(19) United States
(12) Patent Application Publication
(10) Pub. No.: US 2022/0143789 A1
(43) Pub. Date: May 12, 2022

(54) ELECTRIC TOOL

(71) Applicant: Panasonic Intellectual Property Management Co., Ltd., Osaka (JP)

(72) Inventors: Takashi Kusagawa, Osaka (JP); Mitsumasa MIZUNO, Osaka (JP); Itaru MURUI, Nara (JP)

(21) Appl. No.: 17/438,391

(22) PCT Filed: Jan. 22, 2020
(86) PCT No.: PCT/JP2020/002017

§ 371 Date: Sep. 10, 2021

(30) Foreign Application Priority Data
Mar. 11, 2019 (JP) 2019-043829

(51) Int. Cl. B25B 21/02; B25F 5/00

(52) U.S. Cl. CPC B25B 21/026; B25F 5/001

(57) ABSTRACT

A torque transmission mechanism includes a magnet coupling including a driving magnet member coupled to a driving shaft side and a driven magnet member coupled to an output shaft side. One of the driving magnet member or the driven magnet member rotatably supports the other of the driving magnet member or the driven magnet member.

### TECHNICAL FIELD

The present disclosure relates to an electric power tool adapted to transmit a torque produced by the rotation of a driving shaft to an output shaft so as to rotate a front-end tool.

### BACKGROUND ART

Patent literature 1 discloses an electric power tool including: a driving shaft that is driven into rotation by a motor; an output shaft on which a front-end tool is attachable; and a torque transmission mechanism that transmits a torque produced by the rotation of the driving shaft to the output shaft. The torque transmission mechanism includes a magnet coupling including a driving magnet member coupled to the driving shaft side and a driven magnet member coupled to the output shaft side. The driving magnet member and the driven magnet member are arranged such that the respective magnetic surfaces face each other, S-poles and N-poles being alternately arranged on each magnetic surface. The magnet coupling has the function of applying an intermittent rotary impact force to the output shaft and applies an intermittent rotary impact force to the output shaft by changing the magnetic force exerted between the magnetic surface of the driving magnet member and the magnetic surface of the driven magnet member.
[Patent Literature 1] JP2018-140446

### SUMMARY OF INVENTION

### Technical Problem

When a gap between the magnetic surface of the driving magnet member and the magnetic surface of the driven magnet member changes in the electric power tool provided with the magnet coupling, it is difficult to generate a rotary impact force in a stable manner.

The present disclosure addresses the above-described issue, and a general purpose thereof is to provide a structure for generating a rotary impact force in a stable manner.

### Solution to Problem

An electric power tool according to an embodiment of the present disclosure includes: a driving shaft that is driven into rotation by a motor; an output shaft on which a front-end tool is attachable; and a torque transmission mechanism that includes a magnet coupling including a driving magnet member coupled to the driving shaft side and a driven magnet member coupled to the output shaft side, one of the driving magnet member or the driven magnet member rotatably supporting the other of the driving magnet member or the driven magnet member.

### BRIEF DESCRIPTION OF DRAWINGS

FIG. 1 shows an exemplary configuration of an electric power tool;

FIG. 2 shows an exemplary internal structure of the magnet coupling;

FIG. 3 shows a state transition of the magnet coupling;

FIG. 4 shows an exemplary support structure in the torque transmission mechanism;

FIG. 5 shows another exemplary support structure in the torque transmission mechanism;

FIG. 6 shows still another exemplary support structure in the torque transmission mechanism; and

FIG. 7 shows still another exemplary support structure in the torque transmission mechanism.

### DESCRIPTION OF EMBODIMENTS

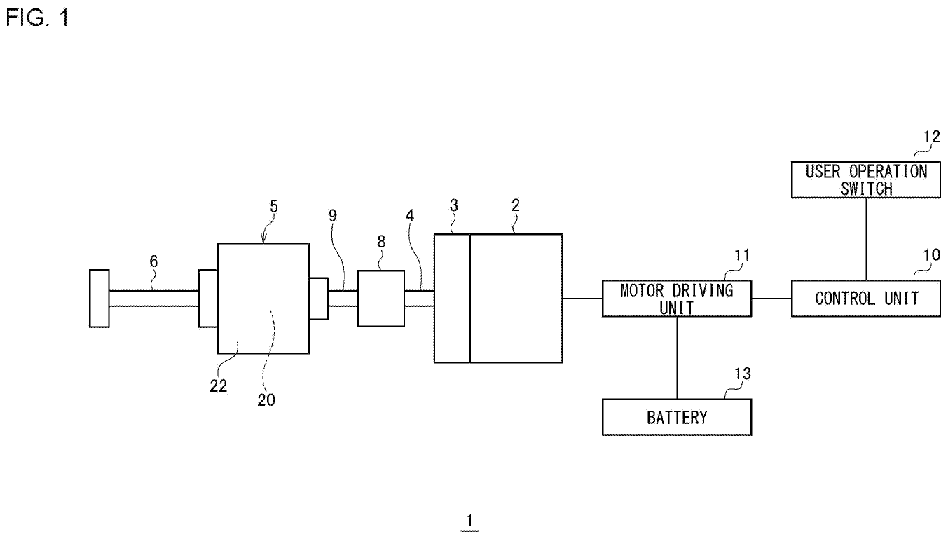

FIG. 1 shows an exemplary configuration of an electric power tool 1 according to an embodiment of the present disclosure. The electric power tool 1 is a rotary tool in which a motor 2 is a driving source and includes a driving shaft 4 driven into rotation by the motor 2, an output shaft 6 on which a front-end tool can be attached, a torque transmission mechanism 5 for transmitting a torque produced by the rotation of the driving shaft 4 to the output shaft 6, and a clutch mechanism 8 provided between the motor 2 and the torque transmission mechanism 5. The clutch mechanism 8 is configured as a mechanical element that transmits the torque produced by the rotation of the driving shaft 4 to the torque transmission mechanism 5 via a coupling shaft 9 but does not transmit the torque the coupling shaft 9 receives from the torque transmission mechanism 5 to the driving shaft 4.

Power is supplied from a battery 13 built in a battery pack. The motor 2 is driven by a motor driving unit 11, and the rotation of the rotary shaft of the motor 2 is decelerated by a decelerator 3 and transmitted to the driving shaft 4. The clutch mechanism 8 transmits the rotation torque of the driving shaft 4 to the torque transmission mechanism 5 via the coupling shaft.

The control unit 10 has the function of controlling the rotation of the motor 2. A user operation switch 12 is a trigger switch manipulated by a user. The control unit 10 turns the motor 2 on or off according to the manipulation of the user operation switch 12 and supplies the motor driving unit 11 with an instruction for driving determined by a manipulation variable of the user operation switch 12. The motor driving unit 11 controls the voltage applied to the motor 2 according to the instruction for driving supplied from the control unit 10 to adjust the number of revolutions of the motor.

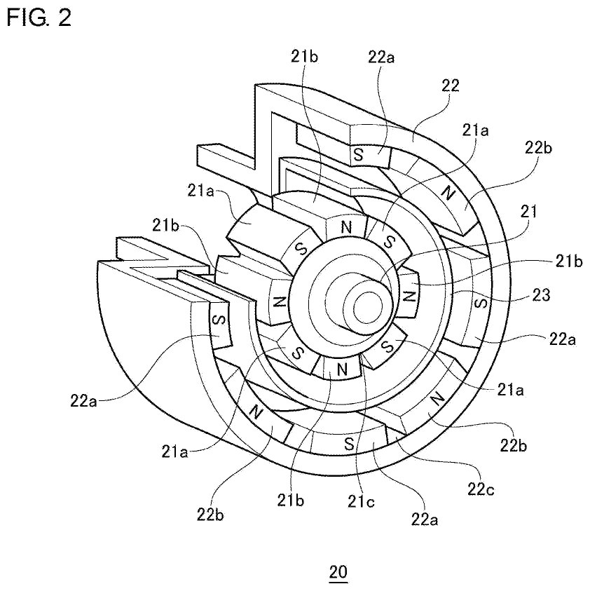

The torque transmission mechanism 5 according to the embodiment includes a magnet coupling 20 that enables contactless torque transmission. FIG. 2 shows an exemplary internal structure of the magnet coupling 20. FIG. 2 shows a perspective cross section in which a part of the cylinder-type magnet coupling 20 having an inner rotor and an outer rotor is cut out. S-poles and N-poles are alternately arranged adjacent to each other in the circumferential direction on the outer circumferential surface of the inner rotor cylinder and on the inner circumferential surface of the outer rotor cylinder. The magnet coupling 20 realizes superbly quiet torque transmission by magnetically transmitting the torque produced by the rotation of the driving shaft 4 to the output shaft 6. FIG. 2 shows the magnet coupling 20 of an eight-pole type, but the number of poles is not limited to eight.

The magnet coupling 20 includes a driving magnet member 21 coupled to the driving shaft 4 side, a driven magnet member 22 coupled to the output shaft 6 side, and a partition wall 23 provided between the driving magnet member 21 and the driven magnet member 22. In the magnet coupling 20 according to the embodiment, the driving magnet member 21 is an inner rotor, the driven magnet member 22 is an outer rotor. The moment of inertia of the driven magnet member 22 side is configured to be larger than the moment of inertia of the driving magnet member 21 side.

The outer circumferential surface of the driving magnet member 21 forms a magnetic surface 21c on which S-pole magnets 21a and N-pole magnets 21b are alternately arranged, and the inner circumferential surface of the driven magnet member 22 forms a magnetic surface 22c on which S-pole magnets 22a and N-pole magnets 22b are alternately arranged. The angular pitches of magnetic pole arrangement are configured to be equal in the magnetic surface 21c and the magnetic surface 22c. It is preferred that the S-pole magnets and the N-pole magnets be arranged alternately without creating gaps between the poles.

The driving magnet member 21 and the driven magnet member 22 are arranged coaxially such that the magnetic surface 21c and the magnetic surface 22c face each other. The attraction exerted between the S-pole magnet 21a and the N-pole magnet 22b and between the N-pole magnet 21b and the S-pole magnet 22a in the direction in which the magnets face defines the relative positions of the driving magnet member 21 and the driven magnet member 22.

By employing the magnet coupling 20, it is possible to transmit a torque in a contactless manner and improve quietness of the electric power tool 1. By alternately arranging S-poles and N-poles adjacent to each other on the magnetic surface 21c and alternately arranging S-poles and N-poles adjacent to each other on the magnetic surface 22c, the magnet coupling 20 is capable of transmitting a larger torque as compared with a case of arranging the S-poles and the N-poles at a distance.

A description will now be given of a case of using the electric power tool 1 as a rotary impact tool. The rotary impact tool applies a striking impact force intermittently to a screw member such as a bolt subject to tightening in the rotational direction. This is met in the embodiment by allowing the magnet coupling 20 that forms the torque transmission mechanism 5 to have the function of generating an intermittent rotary impact force. The magnet coupling 20 applies an intermittent rotary impact force to the screw member via the front-end tool attached to the output shaft 6 by changing the magnetic force exerted between the magnetic surface 21c of the driving magnet member 21 and the magnetic surface 22c of the driven magnet member 22.

Unless a load torque equal to or beyond the maximum torque that can be transmitted is exerted, the driving magnet member 21 and the driven magnet member 22 of the magnet coupling 20 are rotated in synchronization, substantially maintaining the relative positions in the rotational direction. As the tightening of the screw member progresses and a load torque beyond the maximum torque that can be transmitted by the magnet coupling 20 is exerted on the output shaft 6 side, however, the driven magnet member 22 will be unable to follow the driving magnet member 21. The state in which the driving magnet member 21 and the driven magnet member 22 are not synchronized will be referred to as “loss of synchronization”. The electric power tool 1 generates an intermittent rotary impact force by using loss of synchronization.

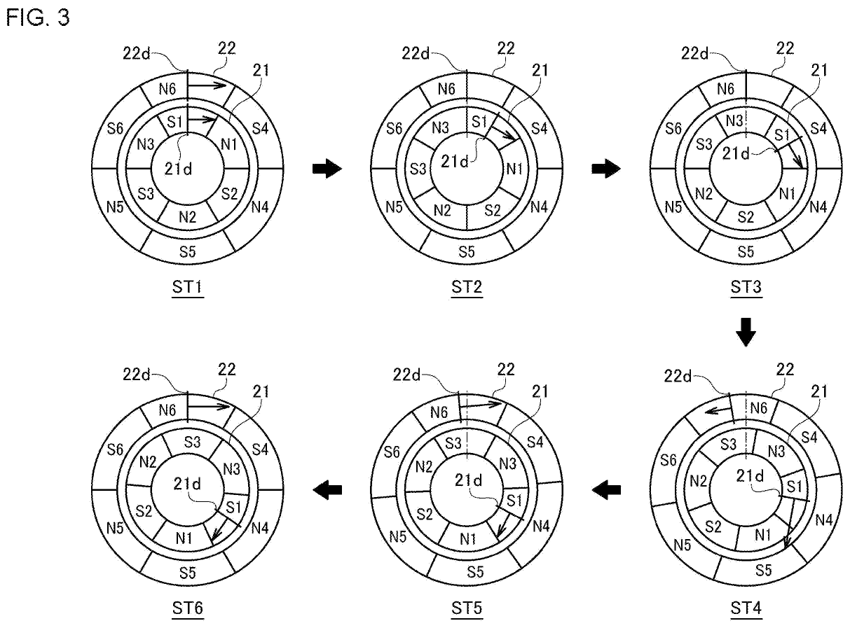

FIG. 3 shows a state transition of the magnet coupling 20 occurring when the bolt is tightened. FIG. 3 shows relative positions of the driving magnet member 21 and the driven magnet member 22 in a 6-pole type magnet coupling 20. Magnets S1, S2, S3 and magnets N1, N2, N3 are the S-pole magnet 21a and the N-pole magnet 21b in the driving magnet member 21, respectively, and magnets S4, S5, S6 and magnets N4, N5, N6 are the S-pole magnet 22a and the N-pole magnet 22b in the driven magnet member 22, respectively.

The state ST1 is defined as a state in which the driving magnet member 21 is driven into rotation by the motor 2, and the driving magnet member 21 and the driven magnet member 22 maintain the relative synchronous positions. In the state ST1, the driven magnet member 22 is rotated by following the rotation of the driving magnet member 21 so that the driven magnet member 22 is slightly behind the driving magnet member 21 in phase, but the members are illustrated as being in the same phase in this example. To facilitate the understanding of the relative phases of the members, a reference position 22d of the magnet N6 and a reference position 21d of the magnet S1, which are in the same phase in the state ST1, are defined.

The state ST2 is defined as a state that occurs immediately before the driven magnet member 22 cannot follow the driving magnet member 21. When a load torque beyond the maximum torque that can be transmitted by the magnet coupling 20 is exerted on the output shaft 6 while the bolt is being tightened, the rotation of the driven magnet member 22 coupled to the output shaft 6 side is stopped, and the driving magnet member 21 starts idling relative to the driven magnet member 22.

The state ST3 occurs while synchronization is being lost and is defined as a state in which the S-pole magnet 21a and the N-pole magnet 21b in the driving magnet member 21 and the S-pole magnet 22a and the N-pole magnet 22b in the driven magnet member 22 face each other, respectively. In this state, the repulsive magnetic force exerted between the driving magnet member 21 and the driven magnet member 22 reaches the maximum level.

The state ST4 is defined as a state in which the driving magnet member 21 and the driven magnet member 22 receive the impact of the repulsive forces of the respective magnets and are moved in the rotational directions opposite to each other. The driving magnet member 21 is rotated at a speed higher than the speed at which the motor 2 rotates the driving shaft 4. The driven magnet member 22 is rotated in the reverse direction from the stopping position.

To focus on the magnet S1 of the driving magnet member 21, the maximum repulsive magnetic force is exerted between the magnet S1 and the magnet S4 in the state ST3. As the driving magnet member 21 is rotated further beyond the state ST3, the magnet S1 is driven by the repulsive magnetic force of the magnet S4 in the rotational direction away from the magnet S4 and is attracted by the attractive magnetic force of the magnet N4 into the rotational direction. Like the magnet S1, the other magnets S2-S3 and magnets N1-N3 in the driving magnet member 21 receive a magnetic force from the driven magnet member 22 similarly. Therefore, the driving magnet member 21 is rotated in the state ST4 at a speed higher than the speed at which the motor 2 rotates the driving shaft 4.

The clutch mechanism 8 transmits the torque produced by the rotation of the driving shaft 4 to the driving magnet member 21 via the coupling shaft 9 but does not transmit the torque the driving magnet member 21 receives from the driven magnet member 22, i.e., the rotation torque produced by the attractive magnetic force in the direction of advancement, to the driving shaft 4. A situation in which the motor 2 represents a load for the rotation torque produced by the attractive magnetic force can be avoided by causing the clutch mechanism 8 to interrupt torque transmission between the driving shaft 4 and the driving magnet member 21 when the driving magnet member 21 is rotated at a speed higher than the speed of rotation by the motor 2.

To focus on the magnet S4 of the driven magnet member 22, the maximum repulsive magnetic force is exerted between the magnet S4 and the magnet S1 in the state ST3. As the driving magnet member 21 is rotated further beyond the state ST3, the magnet S4 is driven by the repulsive magnetic force of the magnet S1 in the reverse rotational direction away from the magnet S1 and is attracted by the attractive magnetic force of the magnet N3 into the reverse rotational direction. Like the magnet S4, the other magnets S5-S6 and magnets N4-N6 in the driven magnet member 22 receive a magnetic force from the driving magnet member 21 similarly. In the state ST4, therefore, the driven magnet member 22 is rotated in a direction opposite to the rotational direction of the driving magnet member 21.

The rotation of the driven magnet member 22 in the reverse direction is the rotation in the direction to loosen the bolt. Thus, it is preferred to control the maximum angle of rotation of the driven magnet member 22 in the reverse direction to be smaller than the rotational allowance angle of the front-end tool so as not to loosen the bolt. The rotational allowance angle of the front-end tool may be defined as an angle derived from adding the allowance angle between the front-end tool and the output shaft 6 to the allowance angle between the front-end tool and the bolt subject to tightening.

The state ST5 is defined as a state in which the driven magnet member 22 put into reverse rotation in the state ST4 is rotated in the normal direction, i.e., the direction in which the front-end tool tightens the bolt. In the electric power tool 1, the driving magnet member 21 is prevented by the clutch mechanism 8 to be put into reverse rotation and is always normally rotated. After being put into reverse rotation in the state ST4, the driven magnet member 22 is caused by the attractive magnetic force of the normally rotating driving magnet member 21 to be rotated in the normal direction toward the previous stopping position (the position to tighten the bolt).

The state ST6 is defined as a state in which the driven magnet member 22 is normally rotated as far as the previous stopping position shown in the state ST1 so as to transmit the rotary impact force to the bolt. This rotary impact force rotates the bolt in the tightening direction. The magnet coupling 20 applies an intermittent rotary impact force to the bolt by repeating the state transition from the state ST2 to the state ST6.

The torque transmission mechanism 5 according to the embodiment generates an intermittent rotary impact force by using loss of synchronization in the magnet coupling 20. The timing of loss of synchronization is determined by the magnetic force exerted between the driving magnet member 21 and the driven magnet member 22. When a gap between the magnetic surface 21c of the driving magnet member 21 and the magnetic surface 22c of the driven magnet member 22 changes, the timing of loss of synchronization changes, and it becomes difficult to generate a rotary impact force in a stable manner.

Accordingly, the torque transmission mechanism 5 is provided with a structure in which one of the driving magnet member 21 or the driven magnet member 22 rotatably supports the other of the driving magnet member 21 or the driven magnet member 22. By providing a support structure between the driving magnet member 21 and the driven magnet member 22, the relative positions of the driving magnet member 21 and the driven magnet member 22 can be maintained.

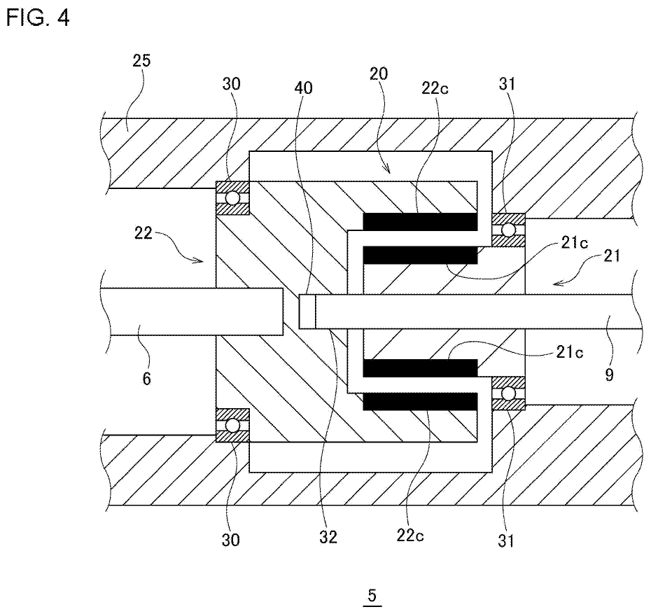

FIG. 4 shows an exemplary support structure in the torque transmission mechanism 5. In the magnet coupling 20, the driving magnet member 21 and the driven magnet member 22 are arranged coaxially such that the magnetic surface 21c and the magnetic surface 22c face each other. A housing 25 rotatably supports the driven magnet member 22 with a first bearing part 30 and rotatably supports the driving magnet member 21 with a second bearing part 31. By supporting the driven magnet member 22 and the driving magnet member 21 with respect to the common housing 25, eccentricity is inhibited, and the output shaft 6 and the coupling shaft 9 can be maintained to be coaxial.

One of the driving magnet member 21 or the driven magnet member 22 rotatably supports the other of the driving magnet member 21 or the driven magnet member 22. In the support structure shown in FIG. 4, the driven magnet member 22 has a shaft support hole 40 coaxial with the output shaft 6, and the end of the coupling shaft 9 is inserted in the shaft support hole 40. The shaft support hole 40 is used as a third bearing part 32 that is a slip bearing. The driven magnet member 22 rotatably supports the driving magnet member 21 with the third bearing part 32.

In the torque transmission mechanism 5 shown in FIG. 4, the first bearing part 30 and the second bearing part 31 support the magnet coupling 20 to be rotatable with respect to the housing 25, and the third bearing part 32 supports the driving magnet member 21 to be rotatable with respect to the driven magnet member 22. This maintains the gap between the magnetic surface 21c and the magnetic surface 22c to be constant. It has been described with reference to FIG. 4 that the driven magnet member 22 rotatably supports the driving magnet member 21, but it can also be seen that the driving magnet member 21 rotatably supports the driven magnet member 22.

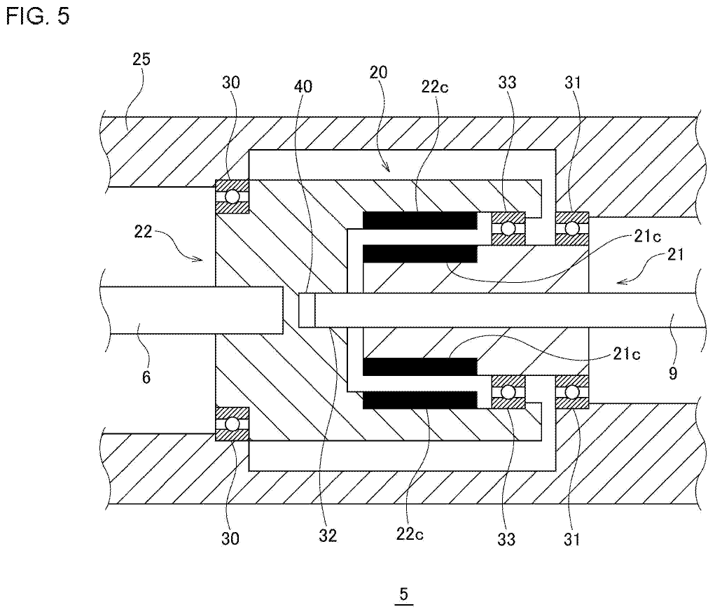

FIG. 5 shows another exemplary support structure in the torque transmission mechanism 5. In the magnet coupling 20, the driving magnet member 21 and the driven magnet member 22 are arranged coaxially such that the magnetic surface 21c and the magnetic surface 22c face each other. The housing 25 rotatably supports the driven magnet member 22 with the first bearing part 30 and supports the driving magnet member 21 with the second bearing part 31. One of the driving magnet member 21 or the driven magnet member 22 rotatably supports the other of the driving magnet member 21 or the driven magnet member 22 in at least two locations.

The driven magnet member 22 has the shaft support hole 40 coaxial with the output shaft 6, and the end of the coupling shaft 9 is inserted in the shaft support hole 40. The shaft support hole 40 is used as the third bearing part 32 that is a slip bearing. The driven magnet member 22 rotatably supports the driving magnet member 21 with the third bearing part 32.

Further, the driven magnet member 22 rotatably supports the driving magnet member 21 with a fourth bearing part 33. By causing the driven magnet member 22 to rotatably support the driving magnet member 21 in two locations, the gap between the magnetic surface 21c and the magnetic surface 22c can be maintained to be constant.

It is preferred that the driven magnet member 22 supports the driving magnet member 21 in two locations sandwiching the magnetic surface 21c and the magnetic surface 22c. By causing the driving magnet member 21 to be supported by the driven magnet member 22 in two locations sandwiching the magnetic surface 21c and the magnetic surface 22c, the gap between the magnetic surface 21c and the magnetic surface 22c can be maintained to be constant.

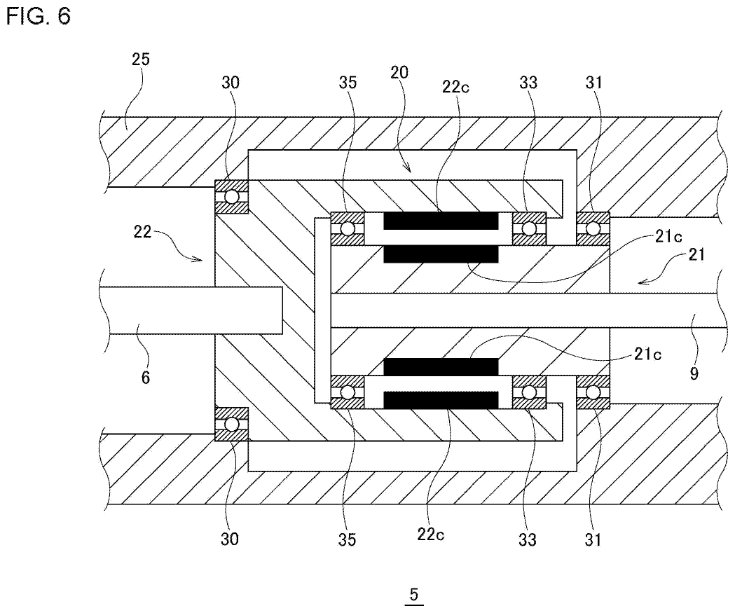

FIG. 6 shows still another exemplary support structure in the torque transmission mechanism 5. In the magnet coupling 20, the driving magnet member 21 and the driven magnet member 22 are arranged coaxially such that the magnetic surface 21c and the magnetic surface 22c face each other. The housing 25 rotatably supports the driven magnet member 22 with the first bearing part 30 and rotatably supports the driving magnet member 21 with the second bearing part 31. One of the driving magnet member 21 or the driven magnet member 22 rotatably supports the other of the driving magnet member 21 or the driven magnet member 22 in at least two locations.

The driven magnet member 22 rotatably supports the driving magnet member 21 with a third bearing part 35 and the fourth bearing part 33. By causing the driven magnet member 22 to rotatably support the driving magnet member 21 in two locations sandwiching the magnetic surface 21c and the magnetic surface 22c, the relative positions of the driving magnet member 21 and the driven magnet member 22 can be maintained properly.

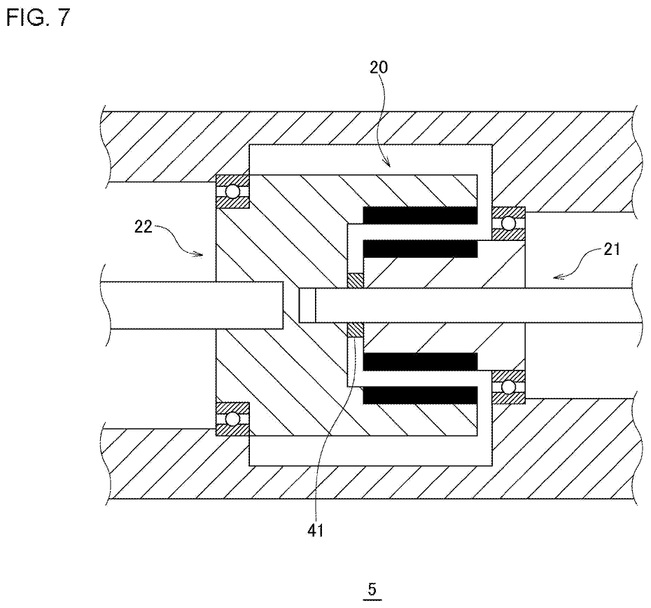

FIG. 7 shows still another exemplary support structure in the torque transmission mechanism 5. A spacer 41 for inhibiting relative axial movement of the driving magnet member 21 and the driven magnet member 22 is provided between the driving magnet member 21 and the driven magnet member 22. The spacer 41 may be a thrust bearing. By inhibiting relative axial movement, the electric power tool 1 can generate a rotary impact force in a stable manner.

Described above is an explanation based on an embodiment. The embodiment is intended to be illustrative only and it will be understood by those skilled in the art that various modifications to constituting elements and processes could be developed and that such modifications are also within the scope of the present disclosure.

A summary of an embodiment of the present disclosure is given below. An electric power tool according to an embodiment of the present disclosure includes: a driving shaft (4) that is driven into rotation by a motor (2); an output shaft (6) on which a front-end tool is attachable; a torque transmission mechanism (5) that includes a magnet coupling (20) including a driving magnet member (21) coupled to the driving shaft side and a driven magnet member (22) coupled to the output shaft side, one of the driving magnet member (21) or the driven magnet member (22) rotatably supporting the other of the driving magnet member (21) or the driven magnet member (22).

One of the driving magnet member (21) or the driven magnet member (22) may rotatably support the other of the driving magnet member (21) or the driven magnet member (22) in two locations. The driving magnet member (21) and the driven magnet member (22) may be arranged such that respective magnetic surfaces face each other, S-poles and N-poles being alternately arranged on each magnetic surface, and one of the driving magnet member (21) or the driven magnet member (22) may rotatably support the other of the driving magnet member (21) or the driven magnet member (22) in two locations sandwiching the magnetic surfaces.

In the magnet coupling (20), a spacer that inhibits relative axial movement of the driving magnet member (21) and the driven magnet member (22) may be provided.

### INDUSTRIAL APPLICABILITY

The present disclosure can be used in electric power tools for rotating a font-end tool.

### REFERENCE SIGNS LIST

1 . . . electric power tool, 2 . . . motor, 3 . . . decelerator, 4 . . . driving shaft, 5 . . . torque transmission mechanism, 6 . . . output shaft, 9 . . . coupling shaft, 20 . . . magnet coupling, 21 . . . driving magnet member, 22 driven magnet member, 25 . . . housing, 30 . . . first bearing part, 31 . . . second bearing part, 32 . . . third bearing part, 33 . . . fourth bearing part, 35 . . . third bearing part, 40 . . . shaft support hole, 41 . . . spacer

1. An electric power tool comprising:
a driving shaft that is driven into rotation by a motor;
an output shaft on which a front-end tool is attachable; and
a torque transmission mechanism that includes a magnet coupling including a driving magnet member coupled to the driving shaft side and a driven magnet member coupled to the output shaft side, one of the driving magnet member or the driven magnet member rotatably supporting the other of the driving magnet member or the driven magnet member.

2. The electric power tool according to claim 1, wherein
one of the driving magnet member or the driven magnet member rotatably supports the other of the driving magnet member or the driven magnet member in two locations.

3. The electric power tool according to claim 2, wherein
the driving magnet member and the driven magnet member are arranged such that respective magnetic surfaces face each other, S-poles and N-poles being alternately arranged on each magnetic surface, and
one of the driving magnet member or the driven magnet member rotatably supports the other of the driving magnet member or the driven magnet member in two locations sandwiching the magnetic surfaces.

4. The electric power tool according to claim 1, wherein
a spacer that inhibits relative axial movement of the driving magnet member and the driven magnet member is provided.
